(19) United States
(12) Patent Application Publication
(10) Pub. No.: US 2025/0239185 A1
(43) Pub. Date: Jul. 24, 2025

(54) LOWER TORSO OVERLAYS FOR PATIENT SIMULATORS

(71) Applicant: GAUMARD SCIENTIFIC COMPANY, INC., Miami, FL (US)

(72) Inventors: Yassel VALDES, Miami, FL (US); Victor FERNANDEZ, Miami, FL (US)

(21) Appl. No.: 19/030,688

(22) Filed: Jan. 17, 2025

Related U.S. Application Data
(60) Provisional application No. 63/623,203, filed on Jan. 19, 2024.

(51) Int. Cl. G09B 23/34

(52) U.S. Cl. CPC G09B 23/34

(57) ABSTRACT

Overlays for patient simulators and associated devices, systems, and methods are provided. In some instances, a patient simulator comprises a simulated torso; and a plurality of overlays configured to be coupled to the simulated torso. Each of the plurality of overlays may include a simulated skin layer and one or more engagement features. The simulated skin layer may be sized and shaped to match an exterior surface of the simulated torso. The one or more engagement features may be configured to engage with one or more corresponding engagement features of the simulated torso. Each of the plurality of overlays may be configured to represent a different medical scenario. The different medical scenarios may comprise different levels and/or types of trauma.

### CROSS-REFERENCE TO RELATED APPLICATIONS

The present application claims priority to and the benefit of U.S. Provisional Patent Application No. 63/623,203, filed Jan. 19, 2024, which is hereby incorporated by reference in its entirety for all applicable purposes.

### INTRODUCTION

The present disclosure relates generally to patient simulators. While it is desirable to train medical personnel in patient care protocols before allowing contact with real patients, textbooks and flash cards lack the important benefits to students that can be attained from hands-on practice. On the other hand, allowing inexperienced students to perform medical procedures on actual patients that would allow for the hands-on practice cannot be considered a viable alternative because of the inherent risk to the patient. Because of these factors patient care education has often been taught using medical instruments to perform patient care activity on a simulator, such as a manikin. Examples of such simulators include those disclosed in U.S. Pat. Nos. 11,756,451, 8,696,362, 8,016,598, 7,976,312, 7,976,313, U.S. patent application Ser. No. 11/952,669 (Publication No. 20090148822), U.S. Pat. Nos. 7,114,954, 6,758,676, 6,503,087, 6,527,558, 6,443,735, 6,193,519, and 5,853,292, each herein incorporated by reference in its entirety.

While these simulators have been adequate in many respects, they have not been adequate in all respects. Therefore, what is needed is an interactive education system for use in conducting patient care training sessions that is even more realistic and/or includes additional simulated features.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

This disclosure describes lower torso skin overlays for patient simulators. In this regard, the lower torso skin overlays of the current disclosure can allow a single patient simulator to provide realistic simulation of a plurality of different medical scenarios associated with the same portion of the simulator by allowing rapid interchanging of different overlays simulating the different medical scenarios. In some instances, a plurality of different overlays are provided that simulate different levels and/or types of trauma. Two or more overlays simulating various classification grades and/or different types of trauma may be provided and selectively interchanged. In this regard, while some of the examples provided herein are related to vaginal or pelvic overlays, it is understood that similar overlays may be used in a variety of other situations and areas of the patient simulator.

In some aspects, a patient simulator comprises a simulated torso; and a plurality of overlays configured to be coupled to the simulated torso. Each of the plurality of overlays may include a simulated skin layer and one or more engagement features. The simulated skin layer may be sized and shaped to match an exterior surface of the simulated torso. The one or more engagement features may be configured to engage with one or more corresponding engagement features of the simulated torso. Each of the plurality of overlays may be configured to represent a different medical scenario. The different medical scenarios may comprise different levels and/or types of trauma. The one or more engagement features may comprise one or more projections and the one or more corresponding engagement features comprise one or more recesses or openings, or vice versa. The simulated skin layer may be an exact offset of the exterior surface of a lower region of the simulated torso. Each of the plurality of overlays may include a portion configured to extend into an interior portion of a vaginal canal of the simulated torso. Each of the plurality of overlays may be configured to be coupled to the simulated torso without an adhesive. Each of the plurality of overlays may be formed of a blend of silicone materials. Each of the plurality of overlays may be painted to represent the different medical scenarios, including bruising, wounds, lesions, etc.

In some aspects, a plurality of overlays for use with a patient simulator comprise: a plurality of overlays configured to be coupled to a simulated torso. Each of the plurality of overlays may include a simulated skin layer and one or more engagement features. The simulated skin layer may be sized and shaped to match an exterior surface of the simulated torso. The one or more engagement features may be configured to engage with one or more corresponding engagement features of the simulated torso. Each of the plurality of overlays may be configured to represent a different medical scenario. The different medical scenarios may comprise different levels and/or types of trauma. The one or more engagement features may comprise one or more projections and the one or more corresponding engagement features comprise one or more recesses or openings, or vice versa. The simulated skin layer may be an exact offset of the exterior surface of a lower region of the simulated torso. Each of the plurality of overlays may include a portion configured to extend into an interior portion of a vaginal canal of the simulated torso. Each of the plurality of overlays may be configured to be coupled to the simulated torso without an adhesive. Each of the plurality of overlays may be formed of a blend of silicone materials. Each of the plurality of overlays may be painted to represent the different medical scenarios, including bruising, wounds, lesions, etc.

Methods of using the plurality of overlays with a patient simulator are also provided. In this regard, a plurality of overlays simulating various classification grades and/or different types of trauma may be provided and selectively interchanged. In this regard, while some of the overlays provided herein are related to vaginal or pelvic overlays, it is understood that similar overlays may be used in a variety of other situations and areas of the patient simulator to simulate other medical conditions.

Other aspects, features, and embodiments of the present invention will become apparent to those of ordinary skill in the art, upon reviewing the following description of specific, exemplary instances of the present invention in conjunction with the accompanying figures. While features of the present invention may be discussed relative to certain examples and figures below, all aspects of the present invention can include one or more of the advantageous features discussed herein. In other words, while one or more arrangements may be discussed as having certain advantageous features, one or more of such features may also be used in accordance with the various aspects and examples of the invention discussed herein. In similar fashion, while exemplary aspects may be discussed below in the context of a device, a system, or a method, it should be understood that such exemplary aspects can be implemented in various devices, systems, and methods.

### BRIEF DESCRIPTION OF THE DRAWINGS

Other features and advantages of the present disclosure will become apparent in the following detailed description of illustrative embodiments with reference to the accompanying of drawings, of which:

FIG. 1 is a perspective view of a patient simulator including a simulated torso, a simulated head, a simulated neck, a simulated right arm, a simulated left arm, a simulated right leg, and a simulated left leg, including at least one skin overlay according to one or more aspects of the present disclosure.

FIG. 2 is a perspective exploded view of a patient simulator and a skin overlay, according to one or more aspects of the present disclosure.

FIG. 3 is a front view of the patient simulator and the skin overlay of FIG. 2 with the skin overlay engaged with the patient simulator, according to one or more aspects of the present disclosure.

FIG. 4 is a perspective view of the patient simulator and the skin overlay of FIGS. 2-3 with the skin overlay engaged with the patient simulator, according to one or more aspects of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications in the described devices, instruments, methods, and any further application of the principles of the disclosure as described herein are contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately. For simplicity, in some instances the same reference numbers are used throughout the drawings to refer to the same or like parts.

One of the aims of healthcare simulation is to establish a teaching environment that closely mimics key clinical cases in a reproducible manner. The introduction of high fidelity tetherless simulators, such as those available from Gaumard Scientific Company, Inc., over the past few years has proven to be a significant advance in creating realistic teaching environments. The present disclosure is directed to a patient simulator that expands the functionality of the simulators by increasing the realism of the look, feel, and functionality of the simulators that can be used to train medical personnel in a variety of clinical situations. The patient simulator disclosed herein offers a training platform on which medical scenarios can be performed for the development of medical treatment skills and the advancement of patient safety. Accordingly, the user's medical treatment skills can be obtained and/or improved in a simulated environment without endangering a live patient. Moreover, the patient simulator allows for multiple users to simultaneously work with the patient simulator during a particular medical scenario, thereby facilitating team training and assessment in a realistic, team-based environment.

In several aspects, the patient simulator includes features designed to enhance the educational experience. For example, in several aspects, the system includes a processing module to simulate different medical and/or surgical scenarios during operation of the patient simulator. In several aspects, the system includes a camera system that allows visualization of the procedure for real-time video and log capture for debriefing purposes. In several aspects, the patient simulator is provided with a workbook of medical scenarios that are pre-programmed in an interactive software package, thereby providing a platform on which medical scenarios can be performed for the development of medical treatment skills and general patient safety. Thus, the patient simulators disclosed herein provide a system that is readily expandable and updatable without large expense and that enables users to learn comprehensive medical and surgical skills through “hands-on” training, without sacrificing the experience gained by users in using standard surgical instruments in a simulated patient treatment situation.

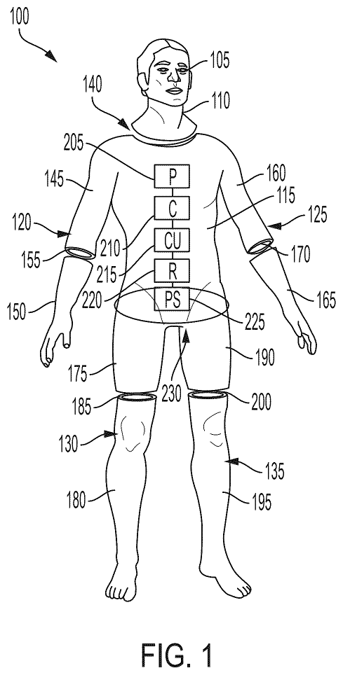

Referring to FIG. 1, in some aspects, a patient simulator is generally referred to by the reference numeral 100 and includes a simulated head 105, a simulated neck 110, a simulated torso 115, a simulated right arm 120 (or “extremity”), a simulated left arm 125 (or “extremity”), a simulated right leg 130 (or “extremity”), and a simulated left leg 135 (or “extremity”). In several embodiments, the patient simulator is, includes, or is part of, a manikin. The simulated head 105 may be coupled to the simulated neck 110. For example, the simulated head 105 may be integrally formed with and/or detachably coupled to the simulated neck 110. The patient simulator 100 may further include a head coupling 140. The simulated neck 110 may be adapted to be detachably coupled to the simulated torso 115 via the head coupling 140. In some aspects, the simulated right arm 120 includes a simulated upper right arm 145 (or “extremity”) and a simulated lower right arm 150 (or “extremity”). The simulated upper right arm 145 may be coupled to the simulated torso 115. For example, the simulated upper right arm 145 may be integrally formed with and/or detachably coupled to the simulated torso 115. The simulated right arm 120 may further include a right arm coupling 155 (or “extremity coupling”). The simulated lower right arm 150 may be detachably coupled to the simulated upper right arm 145 via the right arm coupling 155. Similarly, the simulated left arm 125 may include a simulated upper left arm 160 (or “extremity”) and a simulated lower left arm 165 (or “extremity”). The simulated upper left arm 160 may be coupled to the simulated torso 115. For example, the simulated upper left arm 160 may be integrally formed with and/or detachably coupled to the simulated torso 115. The simulated left arm 125 may further include a left arm coupling 170 (or “extremity coupling”). The simulated lower left arm 165 may be detachably coupled to the simulated upper left arm 160 via the left arm coupling 170.

The simulated right leg 130 may include a simulated upper right leg 175 (or “extremity”) and a simulated lower right leg 180 (or “extremity”). The simulated upper right leg 175 may be coupled to the simulated torso 115. For example, the simulated upper right leg 175 may be integrally formed with and/or detachably coupled to the simulated torso 115. The simulated right leg 130 may further include a right leg coupling 185 (or “extremity coupling”). The simulated lower right leg 180 may be detachably coupled to the simulated upper right leg 175 via the right leg coupling 185. Similarly, the simulated left leg 135 may include a simulated upper left leg 190 (or “extremity”) and a simulated lower left leg 195 (or “extremity”). The simulated upper left leg 190 may be coupled to the simulated torso 115. For example, the simulated upper left leg 190 may be integrally formed with and/or detachably coupled to the simulated torso 115. The simulated left leg 135 may further include a left leg coupling 200 (or “extremity coupling”). The simulated lower left leg 195 may be detachably coupled to the simulated upper left leg 190 via the left leg coupling 200.

In some instances, the simulated torso 115 may be divided into a simulated upper torso and a simulated lower torso. In such instances, the simulated upper right arm 145 and the simulated upper left arm 160 may be coupled to the simulated upper torso. For example, the simulated upper right arm 145 and the simulated upper left arm 160 may be integrally formed with and/or detachably coupled to the simulated upper torso. The simulated upper right leg 175 and the simulated upper left leg 190 may be coupled to the simulated lower torso. For example, the simulated upper right leg 175 and the simulated upper left leg 190 may be integrally formed with and/or detachably coupled to the simulated lower torso. The simulated torso 115 may further includes a torso coupling via which the simulated upper torso may be detachably coupled to the simulated lower torso.

The simulated torso 115 (as well as the simulated head 105, simulated neck 110, simulated right arm 120, simulated left arm 125, a simulated right leg 130, and/or simulated left leg 135) may contain one or more pump(s) 205, compressor(s) 210, control unit(s) 215, reservoir(s) 220, power source(s) 225, and/or other components. The pump(s) 205 may be adapted to supply hydraulic pressure to various features/components of the patient simulator 100. The features/components to which hydraulic pressure is supplied by the pump(s) 205 may be contained in the simulated torso 115, the simulated head 105, the simulated right arm 120, the simulated left arm 125, the simulated right leg 130, and/or the simulated left leg 135. In some instances, the pump(s) 205 may supply hydraulic pressure to one or more of the reservoir(s) 220. For example, the pump(s) 205 may cause fluid to be transferred into and/or out of one or more of the reservoir(s) 220. In this regard, the reservoir(s) 220 may contain fluid and/or gas.

The compressor(s) 210 may be adapted to supply pneumatic pressure to various features/components of the patient simulator 100. The features/components to which pneumatic pressure is supplied by the compressor(s) 210 may be contained in the simulated torso 115, the simulated head 105, the simulated right arm 120, the simulated left arm 125, the simulated right leg 130, and/or the simulated left leg 135. In some instances, the compressor(s) 210 may include a scroll compressor. In some instances, the compressor(s) 210 may supply pneumatic pressure to one or more of the reservoir(s) 220. In this regard, the reservoir(s) 220 may contain fluid and/or gas.

The control unit(s) 215 may be adapted to control the pump(s) 205, the compressor(s) 210, the reservoir(s) 220, including one or more valves associated with the pump(s), compressor(s), and/or reservoir(s), and/or various other features/components of the patient simulator 100. The features/components controlled by the control unit(s) 215 may be contained in the simulated torso 115, the simulated head 105, the simulated right arm 120, the simulated left arm 125, the simulated right leg 130, and/or the simulated left leg 135. In some instances, each of the control unit(s) 215 may be associated with one or more functions and/or features of the patient simulator 100.

The reservoir(s) 220 may contain fluid and/or gas for use in simulating one or more scenarios, functions, and/or features. For example, the reservoir(s) 220 may contain simulated bodily fluids (e.g., blood, urine, saliva, tears, etc.) and/or simulated bodily gasses (e.g., air, O₂, CO₂, etc.). The reservoir(s) 220 may include a single compartment or multiple compartments. The reservoir(s) 220 may be associated with one or more valves to control the flow of fluid and/or gas into and/or out of the reservoir(s) 220.

The power source(s) 225 may supply electrical power to the pump(s) 205, the compressor(s) 210, the control unit(s) 215, the reservoir(s) 220, including one or more valves associated with the pump(s), compressor(s), and/or reservoir(s), and various other features/components of the patient simulator 100. The features/components to which electrical power is supplied by the power source(s) 225 may be contained in the simulated torso 115, the simulated head 105, the simulated right arm 120, the simulated left arm 125, the simulated right leg 130, and/or the simulated left leg 135. The features/components to which electrical power is supplied by the power source(s) 225 may be contained in a different portion of the patient simulator 100 than the power source(s) 225. In some aspects, the power source(s) 225 includes lithium battery technology that reduces weight, volume, and complexity while providing greater power density. However, any suitable battery technology may be used in accordance with the present disclosure, including without limitation lithium, lithium-ion, lithium-sulfur, lithium manganese oxide, lithium polymer, lithium titanate, lithium cobalt oxide, lithium iron phosphate, nickel metal hydride, nickel-cadmium, alkaline, supercapacitor, sodium-ion, magnesium, etc.

In some instances, the power source(s) 225 may be positioned within one or more extremities (e.g., the simulated right arm 120, the simulated left arm 125, the simulated right leg 130, and/or the simulated left leg 135) of the patient simulator 100. In this regard, an extremity containing the power source(s) 225 may be detachably coupled to the simulated torso 115. In some aspects, the extremity containing the power source(s) 225 may include a quick-connect connector to facilitate simple and/or fast power system changes (e.g., by swapping an extremity with a depleted power source for an extremity with a charged power source). In this regard, the quick-connect connector may physically couple the extremity to the simulated torso 115 and/or another aspect of the patient simulator 100 (e.g., upper and/or lower arm, upper and/or lower leg, etc.). The quick-connect connector may also electrically couple the power source(s) 225 contained in the extremity to one or more components of the patient simulator 100 (e.g., the pump(s) 205, the compressor(s) 210, the control unit(s) 215, the reservoir(s) 220, including one or more valves associated with the pump(s), compressor(s), and/or reservoir(s), and various other features/components). In some aspects, the quick-connect connector may also pneumatically and/or fluidly couple one or more components (e.g., pump(s) 205, compressor(s) 210, reservoir(s) 220, valve(s), and other pneumatic and/or fluid components) contained in the extremity (along with the power source(s) 225) to one or more other components of the patient simulator 100 (e.g., the pump(s) 205, the compressor(s) 210, the reservoir(s) 220, valve(s), and various other features/components).

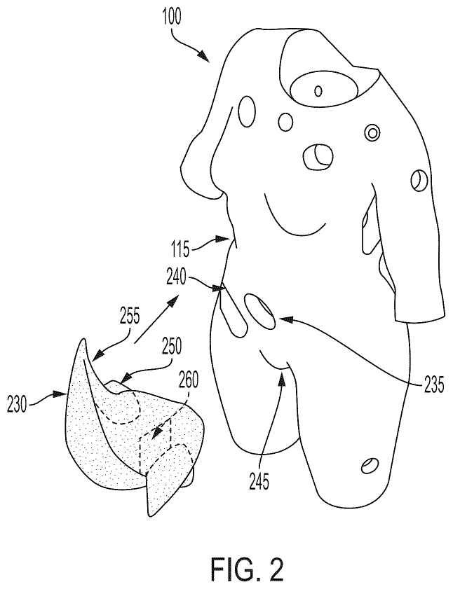

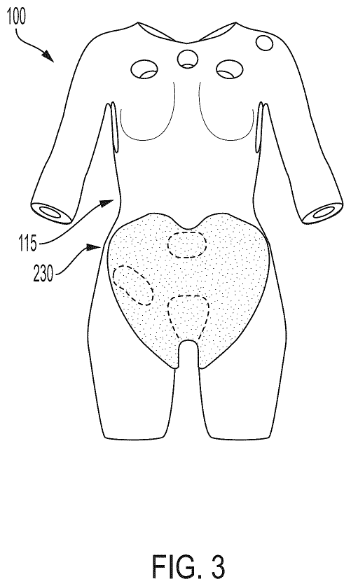

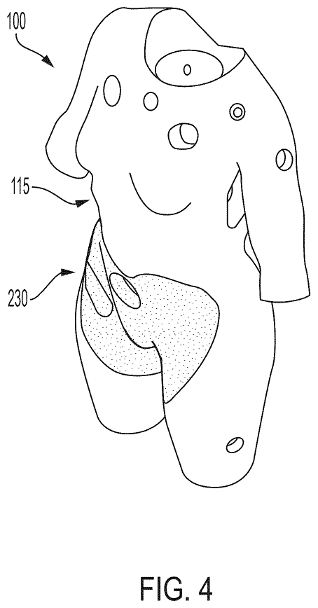

Referring to FIGS. 2-5 and continuing reference to FIG. 1, the patient simulator 100 be configured for use with one or more skin overlays 230. For example, FIG. 2 is a perspective exploded view of a patient simulator 100 and a skin overlay 230, according to one or more aspects of the present disclosure. FIG. 3 is a front view of the patient simulator 100 and the skin overlay 230 of FIG. 2 with the skin overlay engaged with the patient simulator, according to one or more aspects of the present disclosure. FIG. 4 is a perspective view of the patient simulator 100 and the skin overlay 230 of FIGS. 2-3 with the skin overlay engaged with the patient simulator, according to one or more aspects of the present disclosure.

This skin overlays 230 of the present application allow a single patient simulator (e.g., patient simulator 100) to provide realistic simulation of a plurality of different medical scenarios associated with the same portion of the simulator by allowing rapid interchanging of different overlays simulating the different medical scenarios. In some instances, a plurality of different overlays are provided that simulate different levels and/or types of trauma. Two or more overlays simulating various classification grades and/or different types of trauma may be provided and selectively interchanged. In this regard, while some of the examples provided herein are related to vaginal or pelvic overlays, it is understood that similar overlays may be used in a variety of other situations and areas of the patient simulator.

Referring to FIGS. 2-4, the skin overlay 230 may be configured to interface with the torso 115 of the patient simulator 100. For example, the skin overlay 230 may include one or more projections and/or other engagement features configured to engage with one or more recesses, opening, or other engagement features of the torso 115. In some instances, the skin overlay 230 may be an exact offset of an exterior surface of a lower region of the torso 115. In some aspects, the skin overlay may be formed of silicone by injecting molding. In this regard, the mold may be based at least in part on the exterior surface of the lower region of the torso 115. In this regard, the skin overlay 230 may include one or more anchoring points to engage with corresponding features of the torso 115. For example, in the illustrated example the skin overlay 230 may be configured to engage with openings and/or recesses associated with an abdominal wound insert 235, a pelvic wound insert 240, and/or a vaginal canal 245. As shown, the skin overlay 230 may include protruding features 250, 255, and 260 that anchor into and/or otherwise engage with those locations on the torso 115, respectively. In some instances, the vaginal canal region 260 of the skin overlay 230 extends into an interior portion of the vaginal canal 245 of the torso 115 recreating a second layer of the vaginal canal to allow for manual manipulation and/or insertion. In some aspects, the skin overlay 230 couples to the torso 115 without use of an adhesive. In this regard, in some instances the skin overlay 230 and/or the skin layer of the torso 115 is formed of a blend of silicone materials that is tacky. Further, since the skin overlay 230 may conform exactly to the exterior skin surface of the lower region of the torso, further strengthening the bond between the skin overlay 230 and the torso 115 without the need for adhesives or other explicit attachment mechanisms. Further, the silicone blend used for the skin overlays 230 may be paintable to recreate bruises, wounds, lesions, etc. In some aspects, the blend of silicone materials may similar to (or the same as) those described in one or more of U.S. Pat. Nos. 9,472,123, 9,601,032, 10,074,292, and/or 10,741,096, each of which is incorporated by reference in its entirety.

The patient simulator 100 is designed to be used with one or more skin overlays 230 that allow the simulator to realistically replicate a variety of medical scenarios by enabling quick and easy interchange of different overlays that simulate various types and levels of trauma. This flexibility means that a single patient simulator can be adapted to train for multiple medical conditions, enhancing its utility and cost-effectiveness. The overlays can be used in different areas of the simulator, not just in vaginal and/or pelvic regions.

The skin overlays 230 are designed to interface seamlessly with one or more areas of the patient simulator 100. The skin overlays 230 may include projections and engagement features that fit into corresponding recesses and openings of the patient simulator, ensuring a secure fit. The overlays may be made of silicone, molded to match the exterior surface of the patient simulator, and include anchoring points for additional stability. For example, the skin overlays may engage with specific areas like an abdominal wound insert, a pelvic wound insert, and a vaginal canal, with protruding features that anchor into these locations.

One significant advantage of the described skin overlays is that they can be attached without adhesives, thanks to the tacky nature of the silicone material and the precise fit to the exterior surface of the patient simulator. This not only simplifies the attachment process but also enhances the durability and realism of the simulation. Additionally, the silicone material used for the skin overlays is paintable, allowing for the recreation of various skin conditions such as bruises, wounds, and lesions, further enhancing the realism of the training scenarios.

Although illustrative embodiments have been shown and described, a wide range of modification, change, and substitution is contemplated in the foregoing disclosure and in some instances, some features of the present disclosure may be employed without a corresponding use of the other features. It is understood that such variations may be made in the foregoing without departing from the scope of the embodiment. Accordingly, it is appropriate that the appended claims be construed broadly and in a manner consistent with the scope of the present disclosure.

1. A patient simulator, comprising:
a simulated torso; and
a plurality of overlays configured to be coupled to the simulated torso, wherein each of the plurality of overlays includes a simulated skin layer and one or more engagement features, wherein:
the simulated skin layer is sized and shaped to match an exterior surface of the simulated torso;
the one or more engagement features are configured to engage with one or more corresponding engagement features of the simulated torso; and
each of the plurality of overlays is configured to represent a different medical scenario.

2. The patient simulator of claim 1, wherein the different medical scenarios comprise different levels and/or types of trauma.

3. The patient simulator of claim 1, wherein the one or more engagement features comprise one or more projections and the one or more corresponding engagement features comprise one or more recesses or openings.

4. The patient simulator of claim 1, wherein the one or more engagement features comprise one or more recesses or openings and the one or more corresponding engagement features comprise one or more projections.

5. The patient simulator of claim 1, wherein the simulated skin layer is an exact offset of the exterior surface of a lower region of the simulated torso.

6. The patient simulator of claim 5, wherein each of the plurality of overlays includes a portion configured to extend into an interior portion of a vaginal canal of the simulated torso.

7. The patient simulator of claim 1, wherein each of the plurality of overlays is configured to be coupled to the simulated torso without an adhesive.

8. The patient simulator of claim 7, wherein each of the plurality of overlays is formed of a blend of silicone materials.

9. The patient simulator of claim 8, wherein each of the plurality of overlays is painted to represent the different medical scenarios.

10. The patient simulator of claim 9, wherein the different medical scenarios include one or more of a bruise, a wound, or a lesion.

11. A plurality of overlays for use with a patient simulator, the plurality of overlays comprising:
a plurality of overlays configured to be coupled to a simulated torso, wherein each of the plurality of overlays includes a simulated skin layer and one or more engagement features, wherein:
the simulated skin layer is sized and shaped to match an exterior surface of the simulated torso;
the one or more engagement features are configured to engage with one or more corresponding engagement features of the simulated torso; and
each of the plurality of overlays is configured to represent a different medical scenario.

12. The plurality of overlays of claim 11, wherein the different medical scenarios comprise different levels and/or types of trauma.

13. The plurality of overlays of claim 11, wherein the one or more engagement features comprise one or more projections and the one or more corresponding engagement features comprise one or more recesses or openings.

14. The plurality of overlays of claim 11, wherein the one or more engagement features comprise one or more recesses or openings and the one or more corresponding engagement features comprise one or more projections.

15. The plurality of overlays of claim 11, wherein the simulated skin layer is an exact offset of the exterior surface of a lower region of the simulated torso.

16. The plurality of overlays of claim 15, wherein each of the plurality of overlays includes a portion configured to extend into an interior portion of a vaginal canal of the simulated torso.

17. The plurality of overlays of claim 11, wherein each of the plurality of overlays is configured to be coupled to the simulated torso without an adhesive.

18. The plurality of overlays of claim 17, wherein each of the plurality of overlays is formed of a blend of silicone materials.

19. The plurality of overlays of claim 18, wherein each of the plurality of overlays is painted to represent the different medical scenarios.

20. The plurality of overlays of claim 19, wherein the different medical scenarios include one or more of a bruise, a wound, or a lesion.
